(19) United States
(12) Patent Application Publication
(10) Pub. No.: US 2026/0181294 A1
(43) Pub. Date: Jun. 25, 2026

(54) MOTORCYCLE SPEAKER ADAPTER FOR INSTALLATION OF REPLACEMENT SPEAKERS

(71) Applicant: Ronald Barefield, Raleigh, NC (US)

(72) Inventor: Ronald Barefield, Raleigh, NC (US)

(21) Appl. No.: 19/425,037

(22) Filed: Dec. 18, 2025

Related U.S. Application Data
(60) Provisional application No. 63/736,366, filed on Dec. 19, 2024.

(51) Int. Cl. H04R 1/02; B62J 11/00

(52) U.S. Cl. CPC H04R 1/025; B62J 11/00; H04R 1/021; H04R 1/026; H04R 2201/029; H04R 2499/13

(57) ABSTRACT

A motorcycle replacement speaker adapter enabling the installation of speakers without modifying the hard lower components of the motorcycle is disclosed. The replacement speaker adapter has a housing having a front face and sidewalls transversely extending therefrom to define a rear cavity, a front opening, and a rear opening of the housing, wherein said openings are communicative with opposing ends of the rear cavity. A plurality of fastener posts extending rearward from an interior wall of the front face by a plurality of lengths conforming to a fastener pattern of the stock speaker.

### CROSS REFERENCE TO RELATED APPLICATION

This application claims the benefit of priority of U.S. provisional application number 63/736,366, filed Dec. 19, 2024, the contents of which are herein incorporated by reference.

### BACKGROUND OF THE SUBJECT DISCLOSURE

The present subject disclosure relates to motorcycle accessories and, more particularly, to a motorcycle speaker adapter enabling the installation of replacement speakers without the need of modifying the hard lower components of the motorcycle.

The hard lower compartments of a motorcycle are precisely balanced to maximize stability and control of the two-wheeled vehicle, especially when making turns. The factory-installed hard lower compartments of motorcycles, unfortunately, accommodate only the original sized speakers (typically 5.25″ speakers), which limits users looking to enhance their audio experience with larger speaker options. Existing solutions often fail to meet the demands of custom stereo systems and lack compatibility with larger speaker sizes, while also requiring the installer to tinker with the hard lower compartments of the motorcycle, which can require careful dissembling and re-assembly, and where misassembling such components can negatively impact the performance and safety of the motorcycle.

As can be seen, there is a need for a motorcycle speaker adapter enabling the installation of replacement speakers to the original equipment manufacturer (OEM) speakers without modifying the hard lower components of the motorcycle.

### SUMMARY OF THE SUBJECT DISCLOSURE

The subject disclosure addresses the above-mentioned limitations of the prior art by providing a dedicated speaker adapter whose installation does not require altering the original mounting configuration while being configured to support larger-than-OEM speaker size options. The speaker adapter embodied in the subject disclosure seamlessly integrates with the original equipment, facilitating an easy and user-friendly installation process.

The subject disclosure allows motorcycle owners to upgrade their audio systems without altering the original placement or surrounding components of the original speaker, thereby facilitating easy replacement and installation of larger speakers through providing an OEM-compatible solution for enhanced audio performance. The subject disclosure enables customizable options for various speaker sizes to suit individual user preferences.

When the user replaces the OEM stock hard lower speaker holder with the proposed subject disclosure, the speaker adapter enables the accommodation of larger speakers without modification to the hard lower compartments, thereby avoiding deleteriously impacting the future performance of the motorcycle, as well as facilitating easy installation.

In one aspect of the subject disclosure, a method of replacing a stock speaker of a motorcycle with a replacement speaker more voluminous than the stock speaker, the method including the following: reverse engineering a fastener pattern associated with a holder of the stock speaker; assembling an adapter housing having a front face and sidewalls transversely extending therefrom so as to define a rear cavity, a front opening, and a rear opening, said openings are communicative with opposing ends of the rear cavity, wherein the rear cavity is dimensioned and sized to accommodate the replacement speaker; and forming a plurality of fastener posts that extend from an interior wall of the front face by a plurality of lengths conforming to said fastener pattern.

In another aspect of the subject disclosure, a speaker adapter for replacing a stock speaker of a motorcycle includes the following: a housing having a front face and sidewalls transversely extending therefrom so as to define a rear cavity, a front opening, and a rear opening of the housing, wherein said openings are communicative with opposing ends of the rear cavity; and a plurality of fastener posts extending rearward from an interior wall of the front face by a plurality of lengths conforming to a fastener pattern of the stock speaker.

In yet another aspect of the subject disclosure, the speaker adapter for replacing a stock speaker of a motorcycle further includes wherein each length of the plurality of lengths is different than another length of the plurality of lengths; a periphery of the front opening dimensioned and sized to snugly engage a portion of the replacement speaker, said portion rearward of a front of the replacement speaker; a front recess in the front face, wherein the front recess circumscribes the front opening, and wherein the front recess is dimensioned and sized to receive a rearward portion of a face of the replacement speaker.

These and other features, aspects and advantages of the present subject disclosure will become better understood with reference to the following drawings, description and claims.

### BRIEF DESCRIPTION OF THE DRAWINGS

FIG. 1 is a front perspective view of an exemplary embodiment of the subject disclosure.

FIG. 2 is a rear perspective view of an exemplary embodiment of the subject disclosure.

FIG. 3 is a front elevation view of an exemplary embodiment of the subject disclosure.

FIG. 4 is a rear elevation view of an exemplary embodiment of the subject disclosure.

FIG. 5 is a right-side elevation view of an exemplary embodiment of the subject disclosure.

FIG. 6 is a left-side elevation view of an exemplary embodiment of the subject disclosure.

FIG. 7 is a top plan view of an exemplary embodiment of the subject disclosure.

FIG. 8 is a bottom plan view of an exemplary embodiment of the subject disclosure.

FIG. 9 is a section view taken along line 9-9 in FIG. 3.

FIG. 10 is a section view taken along line 10-10 in FIG. 4.

FIG. 11 is a flow chart of an exemplary embodiment of the subject disclosure.

FIG. 12 is a perspective view of an exemplary embodiment of the subject disclosure, illustrating the speaker adapter 10 connected to the stock/OEM face 63 of the stock/OEM speaker enclosure/bucket 62.

FIG. 13 is a perspective view of an exemplary embodiment of the subject disclosure, illustrating the speaker adapter 10 in an environment of use of a motorcycle 60, showing the hard lower component 42 that supports the stock/OEM speaker enclosure/bucket 62 and thus the speaker adapter 10.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

Broadly, an embodiment of the present subject disclosure provides a motorcycle replacement speaker adapter enabling the installation of speakers without modifying the hard lower components of the motorcycle.

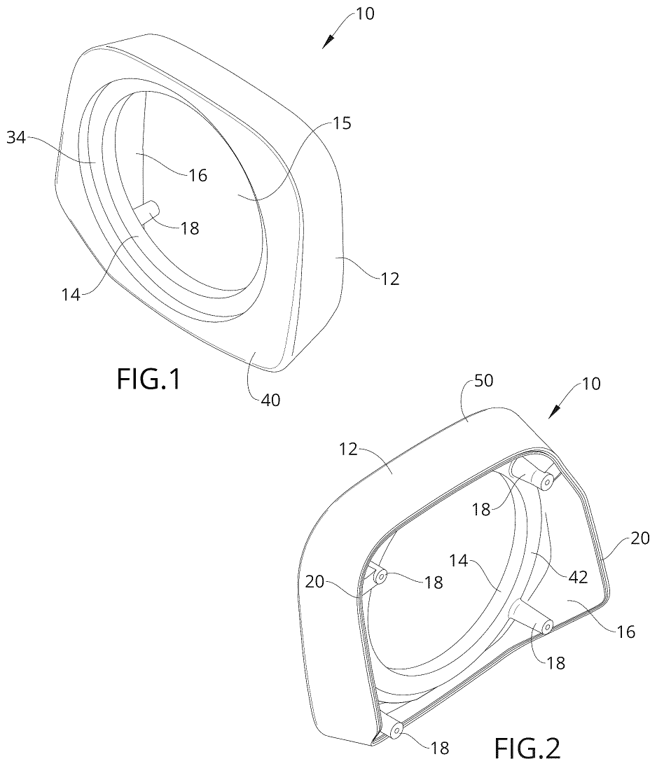

Referring to FIG. 1, the subject disclosure embodies a speaker adapter 10 configured to retrofit a larger speaker to a pre-existing motorcycle. The speaker adapter 10 has a housing 12 that defines a front opening 15, defined by a front face 40, and an opposing rear opening. Both the front opening 15 and the rear opening are communicative with opposing sides of a rear cavity 16. A periphery 20 of the rear opening may include ridges or grooves 20. The groove 20 is to align with the placement on the speaker enclosure (aka bucket), whereby a seal may be formed

The housing 12 has rearward projecting fastener posts 18, wherein the spatial arrangement of each fastener post 18 is configured to match a fastener layout of an OEM speaker holder to be replaced by said speaker adapter 10.

Referring to FIG. 2, an interior surface 42 of front face 40 provides the base from which the fastener posts 18 project rearward to their respective, differing lengths. The front opening 15 is dimensioned and shaped to receive a speaker 66. In some embodiments, the periphery 14 of the front opening 15 may have a diameter of approximately 6.5 inches (compared to an opening of the stock speaker holder, that the subject disclosure replaces, which typically has a diameter of approximately five inches); though in other embodiments the diameter of the periphery 14 may be up to eight inches or greater. The front opening 15 receives the speaker 66, as seen in FIG. 13. The periphery 14 acts as a lip or seat on which the speaker 66 may be supported. A front recess 34 may circumscribe the front opening 15. The flange recess is where a face of the speaker 66 may be received, while the body of the speaker 66 (having a smaller circumference than the face of the speaker 66) is snugly engaged and supported by the periphery/lip 14. The housing 12 has sidewalls 50 extending transversely rearward from the front face 40 to define the sides of the rear cavity 16.

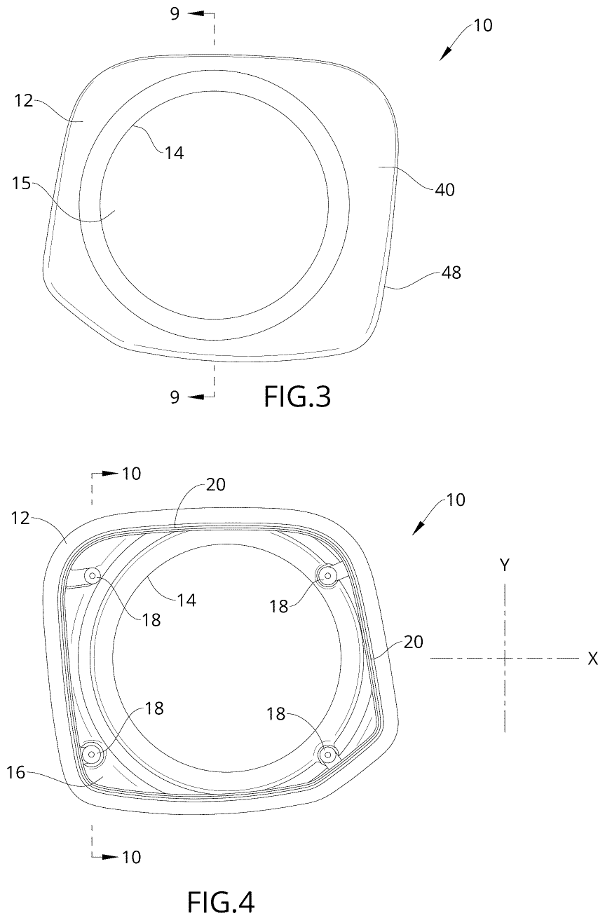

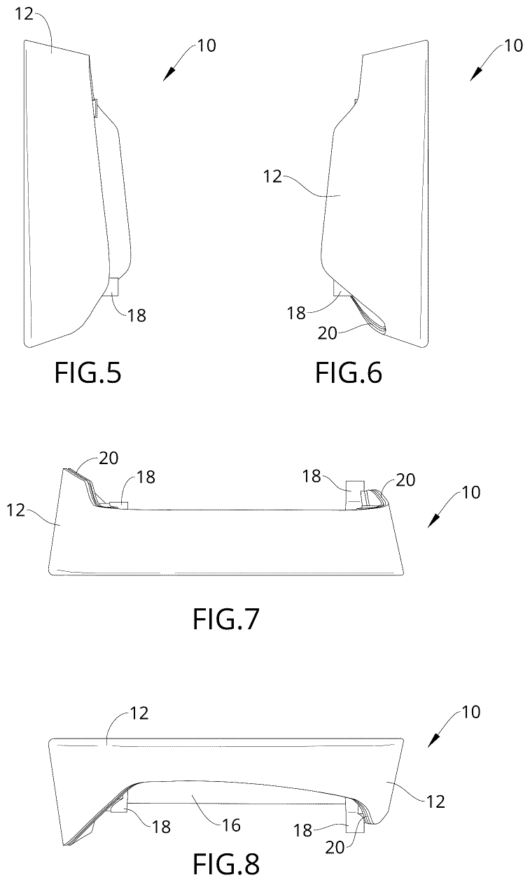

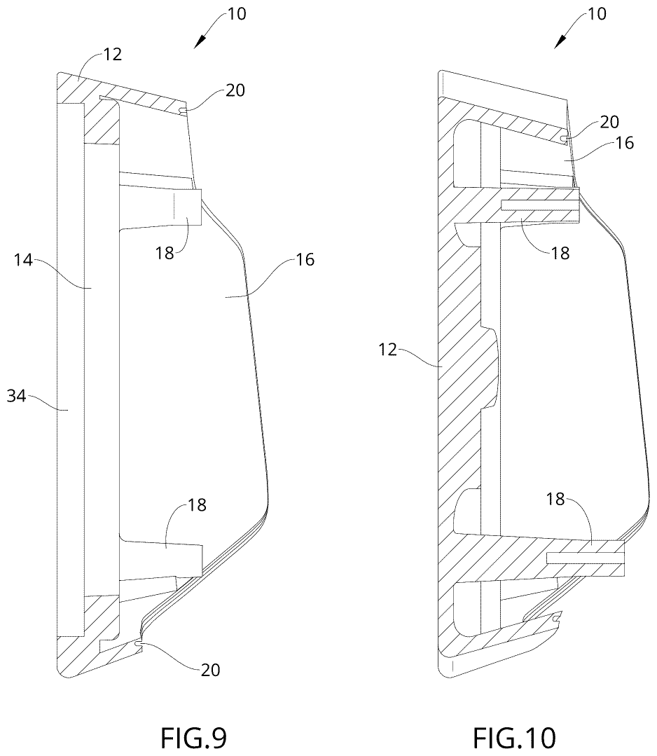

Referring to FIG. 3, the front face 40 may have a non-rectangular or irregular facial periphery 48 accommodating the confines of the hard lower components that is intrinsic to the motorcycle 60.

Referring to FIG. 4, the fastener posts 18 may not be symmetrically arranged (along an x-y framework, wherein left-to-right direction in FIG. 4 is along the x-axis and wherein the top-to-bottom direction in FIG. 4 is the y-axis) relative to the periphery 20 of the rear opening.

The speaker adapter 10 attaches to a stock speaker bucket 62 of the motorcycle 60 and is sealed up to enable larger speakers in the same placement area as the OEM speaker, wherein the speaker adapter 10 is configured to fit larger speakers into the motorcycle's hard lower section 64. The speaker adapter 10 may be fastened onto the hard lower speaker bucket via the stock fastener pattern because the fastener posts 18 are arranged to complement the stock fastener pattern.

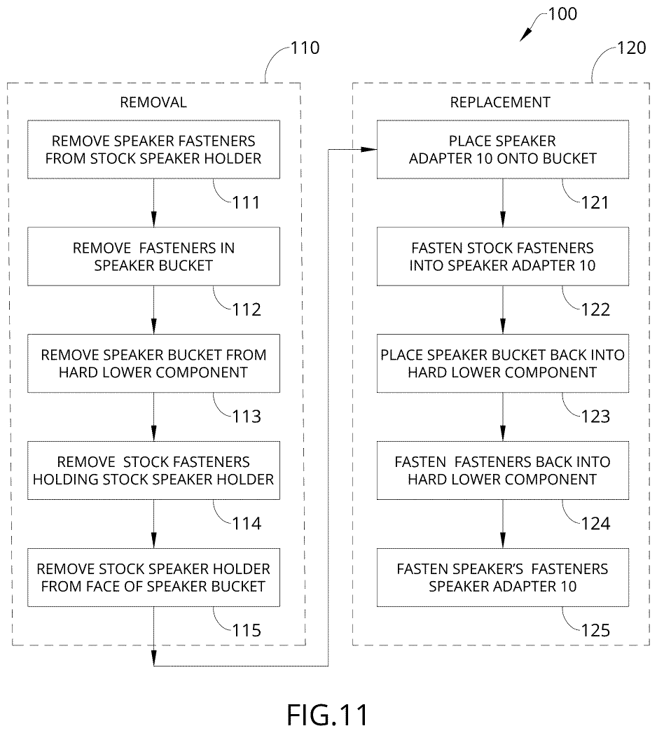

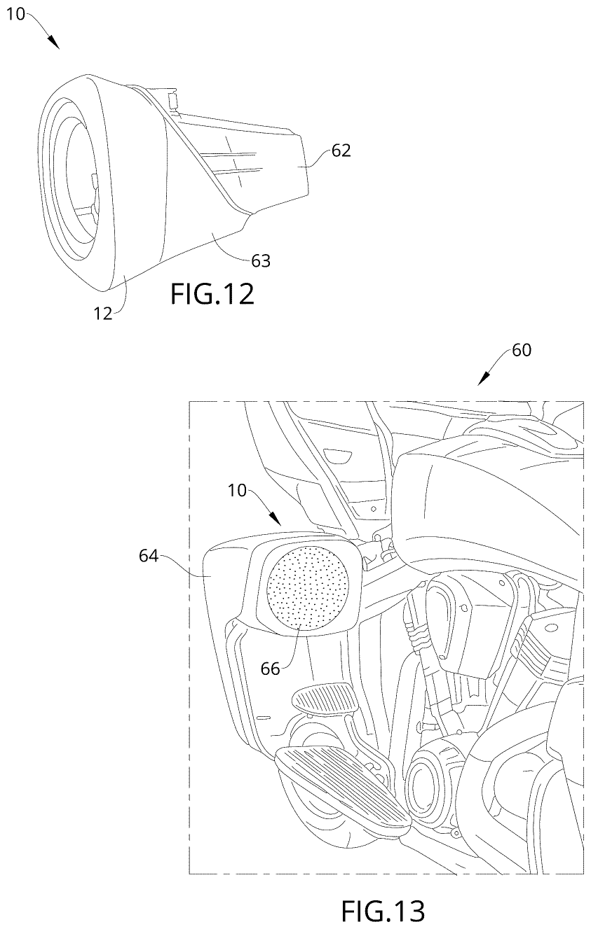

Referring to FIG. 11, replacing an OEM stock speaker holder (not shown) with the speaker adapter 10 for larger speakers may include the following removal process 110 and replacement process 120. The removal process 110 may include the following steps: removal of the stock speaker fasteners from the OEM stock speaker holder, in step 111; remove fasteners in the speaker bucket 62, in step 112; remove speaker bucket from hard lower component 64, in step 113; remove the stock fasteners that secure the stock speaker holder, in step 114; and remove the stock speaker holder from the face 63 the speaker bucket 62, in step 115. The replacement process 120 may include the following steps: place the speaker adapter 10 on the face of the speaker bucket, in step 121; fasten the stock fasteners into the speaker adapter 10, in step 122; place the speaker bucket 62 back in the hard lower component, in step 123; fasten the removed fasteners back into hard lower component (which holds the speaker bucket 62 into place), in step 124; and fastener the removed speaker fasteners into the speaker adapter 10, in step 125.

A method making the subject disclosure may include the following. Create the speaker adapter 10 to hold large size speakers by using the stock fastener pattern through reverse engineering by way of, in some embodiments, forming fiberglass, plastic molding, additive manufacturing (3D print), CNC in aluminum or other materials, or any other sufficiently precision reverse engineering process to capture the stock fastener pattern for embodying the speaker adapter 10 that is also configured to engage a replacement speaker larger than stock size (typically 5.25″). The fastener pattern, which defines the location and lengths of the fastener posts 18, enables fitment of the speaker adapter 10 with the stock speaker bucket and inside the stock hard lower. The speaker adapter 10 may be a single piece of addictive manufacturing whose dimensions and shape are designed based on desired speaker dimensions, angles and lengths of the stock speaker bucket. By configuring a component to fit the stock location as well as stock fastener locations and enlarging the space from the adapter face to the back of the stock speaker bucket, the non-invasive installation of differently sized speakers, without modifying the original layout of the hard lower components is enabled.

A method of using the speaker adapter 10 provides a practical solution for motorcycle enthusiasts seeking to upgrade their sound systems. By enabling the use of larger speakers while retaining the original mounting placement, this subject disclosure enhances the audio quality of motorcycles and meets diverse user needs. Additionally, the subject disclosure enables other applications to install larger speakers by fastening the speaker adapter to the OEM speaker bucket. Furthermore, subject disclosure contemplates use of the speaker adapter 10 on different types of motorcycles tailored to their intrinsic fastener patterns.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A method of replacing a stock speaker of a motorcycle with a replacement, the method comprising:
reverse engineering a fastener pattern associated with a holder of the stock speaker;
assembling an adapter housing having a front face and sidewalls transversely extending therefrom so as to define a rear cavity, a front opening, and a rear opening, said openings are communicative with opposing ends of the rear cavity,
wherein the rear cavity is dimensioned and sized to accommodate the replacement speaker, while a periphery of the front opening is dimensioned to snugly engage a portion of the replacement speaker, said portion just rearward of a face of the replacement speaker; and
forming a plurality of fastener posts that extend from an interior wall of the front face by a plurality of lengths conforming to said fastener pattern.

2. The method of claim 1, wherein each length of the plurality of lengths is different than another length of the plurality of lengths.

3. The method of claim 2, further recessing the front face just outward of the front opening so as to engage a rearward portion of a face of the replacement speaker.

4. A speaker adapter for replacing a stock speaker of a motorcycle with a replacement speaker, the speaker adapter comprising:
a housing having a front face and sidewalls transversely extending therefrom so as to define a rear cavity, a front opening, and a rear opening of the housing, wherein said openings are communicative with opposing ends of the rear cavity; and
a plurality of fastener posts extending rearward from an interior wall of the front face by a plurality of lengths conforming to a fastener pattern of the stock speaker.

5. The speaker adapter of claim 4, wherein each length of the plurality of lengths is different than another length of the plurality of lengths.

6. The speaker adapter of claim 5, further comprising:
a periphery of the front opening dimensioned and sized to snugly engage a portion of the replacement speaker, said portion rearward of a front of the replacement speaker.

7. The speaker adapter of claim 6, further comprising:
a front recess in the front face, wherein the front recess circumscribes the front opening, and wherein the front recess is dimensioned and sized to receive a rearward portion of a face of the replacement speaker.
